(19) United States
(12) Patent Application Publication
(10) Pub. No.: US 2013/0117511 A1
(43) Pub. Date: May 9, 2013

(54) DATA PROCESSING APPARATUS AND METHOD

(71) Applicants: Dominic William BROWN, Ely (GB); Ashley John CRAWFORD, Saffron Walden (GB); Andrew Christopher ROSE, Cambridge (GB)

(72) Inventors: Dominic William BROWN, Ely (GB); Ashley John CRAWFORD, Saffron Walden (GB); Andrew Christopher ROSE, Cambridge (GB)

(73) Assignee: ARM LIMITED, Cambridge (GB)

(21) Appl. No.: 13/291,229

(22) Filed: Nov. 8, 2011

(51) Int. Cl. G06F 12/08

(52) U.S. Cl. 711/141; 711/E12.026

(57) ABSTRACT

A data processing apparatus has a cache having a normal mode and a retention mode in which the cache consumes less power than in the normal mode. An interconnect receives, from at least one other device, coherency access requests for data stored in the cache. In the normal mode, the data in the cache is accessible and the cache generates coherency responses in response to the coherency access requests, while in the retention mode the data is retained in the cache but inaccessible in response to the coherency access requests. A coherency controller is provided to monitor the coherency access requests and coherency responses. Switching of the cache from the normal mode to the retention mode is deferred until the coherency controller has detected coherency responses for all coherency access requests passed to said cache.

### BACKGROUND OF THE INVENTION

1. Field of the Invention

The present invention relates to the field of data processing. More particularly, the invention relates to a data processing apparatus and method for handling coherency access requests for a cache having a retention mode of operation.

2. Description of the Prior Art

In data processing systems having multiple storage devices, versions of the same data may be stored in more than one location within the system. It can be important to ensure that the different versions of the data stay coherent as the data is processed by one or more devices. Therefore, coherency access requests may be exchanged between different devices to maintain consistency between corresponding versions of the same data.

Devices such as a cache memory may operate in a retention mode in which data within the cache is retained while power consumption is reduced in comparison to a normal mode of operation. The retention mode enables the cache to be placed in a power saving state without requiring the cache to be cleaned and re-filled with data on either side of the mode switch.

### SUMMARY OF THE INVENTION

Viewed from one aspect, the present invention provides a data processing apparatus comprising:

a cache having a normal mode of operation and a retention mode of operation in which said cache consumes less power than in said normal mode;

an interconnect configured to receive from at least one other device coherency access requests for data stored in said cache, wherein in said normal mode said data stored in said cache is accessible and said cache is configured to generate coherency responses in response to said coherency access requests, and in said retention mode said data is retained in said cache but is inaccessible in response to said coherency access requests;

a power controller configured to control switching of said cache between said normal mode and said retention mode; and

a coherency controller coupled between said cache and said interconnect and configured to monitor said coherency access requests received via said interconnect and said coherency responses generated by said cache;

wherein on switching said cache from said normal mode to said retention mode, said power controller is configured to defer switching said cache to said retention mode until said coherency controller has detected coherency responses for all coherency access requests passed to said cache.

The present technique recognises that when a cache is placed in a retention mode to reduce power consumption, the data retained in the cache may become inaccessible in response to coherency access requests from at least one other device. If any coherency access requests have been passed to the cache, but have not been fully processed by the cache at the point at which the cache enters the retention mode, then this may lead to incoherency between different versions of the same data. For example, data updated in the other device may not be correctly invalidated in the retained cache so that, when the cache returns to the normal mode, the cache is still storing an out of date version of the data. Also, dirty data in the retained cache, which has been modified but not yet updated in another location such as memory, becomes inaccessible to other devices during the retention mode and so the other device may not be aware that a dirty version of the data is present in the cache, and so may perform processing using an out of date data value.

To address these issues, the present technique provides a coherency controller coupled between the cache and the interconnect for monitoring the coherency access requests received via the interconnect from the at least one other device and the coherency responses generated by the cache in response to the coherency access requests. The coherency controller uses the coherency responses to identify whether coherency access requests have been serviced by the cache. On switching the cache from the normal mode to the retention mode, the power controller defers switching the cache to the retention mode until the coherency controller has detected coherency responses for all coherency access requests that have been passed to the cache. This avoids the potential incoherency that could arise if a coherency access request remains unserviced at the point at which the cache switches to the retention mode.

The coherency controller may trigger the power controller to switch the cache to the normal mode if at least one coherency access request is received via the interconnect while the cache is in the retention mode. This allows the coherency access request to be correctly serviced by the cache once it has returned to the normal mode, so that coherency between data in the cache and data stored at the other device can be maintained. Since the cache can be placed in the retention mode safe in the knowledge that the cache can be returned to the normal mode if required, this enables more frequent use of the retention mode for power saving. There is no need to keep the cache in the normal mode as a precaution in case a coherency access request is received.

The coherency controller may comprise an access gate configured to intercept coherency access requests received via the interconnect and select whether to pass the coherency access requests to the cache or stall the coherency access requests, to ensure that all coherency requests are safely handled. When the cache is in the normal mode, the coherency controller may pass the coherency access requests received by the interconnect to the cache. When a coherency access request is received during the retention mode, the coherency controller may stall the received coherency access request until the power controller has switched the cache to the normal mode. By ensuring that the coherency access request can be issued to the cache only when the cache is in the normal mode, data coherency can be ensured.

The coherency access requests and coherency responses may have various forms, depending on the coherency protocol being used. For example, if the other device updates a data value, it may issue a coherency access request to indicate that the cache should invalidate any corresponding version of the data stored by the cache, and the cache may issue a response confirming that its data value has been invalidated. On the other hand, when the other device issues a coherency access request to snoop the cache to check whether the cache is holding a version of data required by the other device, then the cache may return a coherency response indicating whether the cache holds a version of that data, and if the value stored in the cache is dirty, that the data has been written back to memory to allow the other device to access the latest value of the data from the memory. Alternatively, the cache may pass the dirty value directly to the other device which issued the coherency access request, without writing the data back to memory.

The coherency controller may monitor whether coherency responses have been received for all issued coherency access requests in a number of ways. It is possible that the coherency controller could match received responses to the corresponding coherency access requests to identify which particular coherency access requests remain outstanding.

However, it may not be important which particular coherency access requests remain unserviced. Hence, the coherency controller may simply determine whether all coherency access requests have been serviced without monitoring which particular requests remain unserviced. In such embodiments, the coherency controller may count the number of coherency access requests which have been passed to the cache and count the number of coherency responses received from the cache. The coherency controller may signal to the power controller whether the number of coherency access requests and the number of coherency responses is the same, and the power controller may defer switching the cache to the retention mode until the coherency controller indicates that the number of coherency responses is the same as the number of coherency access requests.

The number of coherency access requests passed to the cache and the number of coherency responses received from the cache may be counted separately. However, in one particularly efficient embodiment the coherency controller may comprise a counter which counts both coherency access requests and coherency responses. The counter may be initialised with a predetermined value. The coherency controller may increment the counter when a coherency access request is passed to the cache and decrement the counter when a coherency response is received from the cache. The power controller may defer switching the cache to the retention mode until the counter has the predetermined value again, indicating that the number of issued coherency access requests is the same as the number of received responses.

The counter allows the monitoring of coherency access requests and coherency responses to be performed with little circuit overhead.

The predetermined value of the counter may be any value. However, it may be most efficient for the predetermined value to be zero, to minimise the number of bits required for the counter.

The terms “increment” and “decrement” are used to indicate adjustments to the counter by a given step value in opposite directions. In one embodiment, “increment” may mean adding a value (e.g. a value of 1) to the counter and “decrement” may mean subtracting that value from the counter. Alternatively, “increment” may mean subtracting and “decrement” may mean adding.

After the coherency controller has detected coherency responses for all coherency access requests passed to the cache, the coherency controller may prevent further coherency requests being passed to the cache until the cache has returned to the normal mode. This avoids coherency access requests being issued to the cache in the period between the coherency controller giving the all clear for the power controller to switch the cache to the retention mode and the power controller actually switching the cache to the retention mode, and so prevents any issued coherency access requests being left unserviced at the point when the cache is switched to the retention mode. If any coherency access requests are received via the interconnect during this period, then the coherency controller can later trigger a switch back to the normal mode to allow the coherency access request to be serviced.

The cache may comprise control circuitry for controlling the cache. For example, the cache control circuitry may include circuitry for controlling accesses to data in the cache and for controlling eviction and replacement of data within the cache. During the retention mode, the cache control circuitry may be placed in a power saving state to reduce power consumption.

While the cache is in the retention mode, the power controller may be configured to switch the cache to the normal mode in response to a service signal received from the at least one other device or from an external device. This allows the other device or the external device to signal to the power controller that the cache should be placed in the normal mode irrespective of whether any coherency access requests have been received. For example, if the other device or external device is about to perform operations which will require access to data in the cache, then the cache can be placed in the normal mode in advance of these operations using the service signal.

The data processing apparatus may comprise a processing circuit for performing processing operations, with the cache storing data for the processing circuit. The processing circuit may issue a wake up request to the power controller while the cache is in the retention mode to indicate to the power controller to switch the cache to the normal mode. For example, if the processing circuit requires data from the cache then the cache can be woken up and brought out of the retention mode. The processing circuit may itself be placed in a power saving state during the retention mode.

While the cache is inaccessible during the retention mode, the at least one other device may be configured to issue non-coherent access requests for data in a memory, which may be an on-chip or off-chip memory. Hence, even while the cache is in retention mode the other device can continue performing data access operations which do not require coherency with respect to the data in the cache.

The at least one other device issuing the coherency access requests may be a local device coupled to the interconnect, or an external device which is not part of the data processing apparatus. The external device may communicate with the interconnect via an input/output port for example.

Viewed from another aspect, the present invention provides a data processing apparatus comprising:

cache means for storing data, said cache means having a normal mode of operation and a retention mode of operation in which said cache means consumes less power than in said normal mode;

interconnect means for receiving from at least one other device coherency access requests for data stored in said cache means, wherein in said normal mode said data is accessible and said cache means is configured to generate coherency responses in response to said coherency access requests, and in said retention mode said data is retained but is inaccessible in response to said coherency access requests;

power control means for controlling switching of said cache means between said normal mode and said retention mode; and

coherency control means, coupled between said cache means and said interconnect means, for monitoring said coherency access requests received via said interconnect means and said coherency responses generated by said cache means;

wherein on switching said cache means from said normal mode to said retention mode, said power control means is configured to defer switching said cache means to said retention mode until said coherency control means has detected coherency responses for all coherency access requests passed to said cache means.

Viewed from a further aspect, the present invention provides a method comprising steps of:

storing data in a cache having a normal mode of operation and a retention mode of operation in which said cache consumes less power than in said normal mode;

receiving, from at least one other device via an interconnect, coherency access requests for data stored in said cache, wherein in said normal mode said data is accessible and said cache generates coherency responses in response to said coherency access requests and in said retention mode said data is retained but is inaccessible in response to said coherency access requests;

monitoring said coherency access requests received via said interconnect and said coherency responses generated by said cache using a coherency controller coupled between said cache and said interconnect; and

on switching said cache from said normal mode to said retention mode, deferring switching said cache to said retention mode until said coherency controller has detected coherency responses for all coherency access requests passed to said cache.

Further particular and preferred aspects of the present invention are set out in the accompanying independent and dependent claims. Features of the dependent claims may be combined with features of the independent claims as appropriate, and in combinations other than those explicitly set out in the claims.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 illustrates a data processing apparatus comprising a coherency controller coupled between a coherent cache and a coherent interconnect;

FIG. 2 illustrates an example of the coherency controller;

FIGS. 3A, 3B and 3C illustrate functions performed by the coherency controller while the cache is in a normal mode;

FIG. 4 illustrates functions performed by a power controller while the cache is in the normal mode;

FIG. 5 illustrates functions performed by the coherency controller while the cache is in a retention mode; and

FIG. 6 illustrates functions performed by the power controller while the cache is in the retention mode.

### DESCRIPTION OF THE EMBODIMENTS

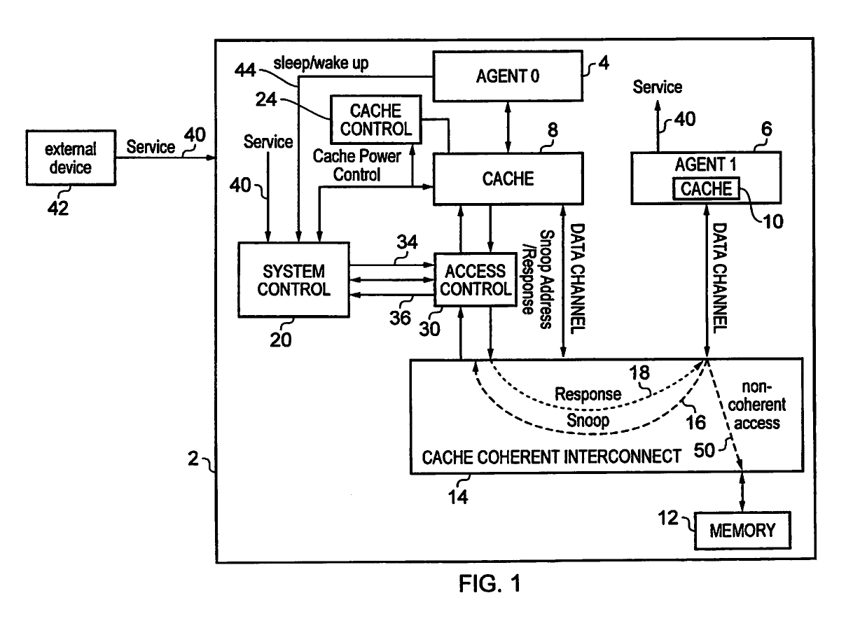

FIG. 1 schematically illustrates a data processing apparatus 2 comprising a first processing circuit 4 and a second processing circuit (“other device”) 6. For example, the processing circuits 4, 6 may comprise a CPU, a graphics processor, a coprocessor, an application specific integrated circuit (ASIC) or another kind of processing circuit. While in this example the second processing circuit 6 is located in the same apparatus 2 as the first processing circuit 4, in another example the second processing circuit 6 may be an external device.

The processing circuit 4 has a cache 8 for storing data on behalf of the processing circuit 4. Similarly, the second processing circuit 6 has a cache 10. Each cache 8, 10 stores data corresponding to data in a memory 12 which is accessible via a cache coherent interconnect 14. Versions of data corresponding to the same location in the memory 12 may be stored in each cache 8, 10. As data is processed by the processing circuits 4, 6, the respective versions of the data in caches 8, 10 may differ. To ensure coherency between the different versions of the same data, the different devices connected to the cache coherent interconnect 14 may issue cache coherency requests (snoop requests) 16 to each other requesting that data is made coherent.

For example, if the device 6 updates a data value corresponding to a location in the memory 12, then the device 6 may issue a snoop request 16 to the cache 8 instructing the cache 8 to invalidate any data corresponding to the same memory location. After the cache 8 has invalidated its version of the data, then the cache 8 may issue a coherency response 18 to the device 6 via the interconnect 14 to indicate that the data has been made coherent.

Alternatively, if the device 6 is seeking data from a particular memory location of the memory 12, and the request for that data misses in the cache 10 of the other device 6, then the device 6 may issue a snoop request 16 to the cache 8 to check whether a version of that data is located in that cache 8. The cache 8 may issue a coherency response 18 indicating whether it is storing a version of that data. If the cache 8 is not storing a version of the data, or the version stored by the cache 8 is clean, then the coherency response 18 can indicate that the device 6 should fetch the data from memory. If the cache 8 is storing a dirty version of the data, then the cache 8 can write the data back to the memory 12 and indicate in the response 18 that the device 6 can now read the written back data value from the corresponding location in memory 12.

Similarly, the processing circuit 4 or cache 8 may issue coherency access requests to the other device 6 to snoop data in the cache 10. Hence, the cache coherency requests are messages for maintaining consistency between different versions of data corresponding to the same memory location of memory 12.

The cache 8 has multiple operating modes including at least a normal operating mode and a retention operating mode (the cache may also have other operating modes). A system controller 20 (also referred to as a power controller) may control whether the cache 8 is operating in the normal mode or the retention mode. In the normal mode, the cache 8 stores data on behalf of the processing circuit 4. The data is accessible to the processing circuit 4 and to other devices in response to snoop requests 16. On the other hand, in the retention mode, the power controller 20 reduces a power supply to the cache 8 so that power consumption of the cache 8 is reduced. The data in the cache 8 is retained during the retention mode but is inaccessible to other devices in response to snoop requests 16. Cache control circuitry 24 for controlling access to the cache is also powered down during the retention mode.

As the cached data is inaccessible during the retention mode, snoop requests 16 cannot be serviced. To allow handling of snoop requests received during the retention mode, an access control gate 30 (also referred to as a coherency controller) is provided between the cache 8 and the coherent interconnect 14 to monitor coherency access requests 16 received from other devices via the interconnect 14 and to control the system controller 20 to switch the cache 8 to the normal mode if a coherency access request 16 is received from another device while the cache 8 is retention mode. This allows coherency to be maintained.

The coherency controller 30 also monitors coherency responses 18 generated by the cache 8 in response to coherency access requests 16 to ensure that, before the system control 20 switches the cache 8 to the retention mode, a response 18 has been received for each issued coherency access request 16. The system controller 20 transmits a request signal 34 to the coherency controller 30 when a switch to retention mode is desired. After responses have been received for all issued coherency access requests 16, the coherency controller 30 responds with a ready signal 36 to the system controller 20. The system controller 20 waits until the ready signal 36 has been received before powering down the cache 8 to switch the cache to the retention mode. This ensures that at the point at which the cache 8 is switched to the retention mode, there are no outstanding snoop access requests 16 which have been issued to the cache 8 but not processed.

The system controller 20 may switch the operating mode of the cache 8 in response to a service signal 40. The service signal 40 may be generated by the other device 6 which issues the coherency access requests or by an external device 42, to indicate that the cache should be kept in normal mode to allow access to the data in the cache 8. While the cache 8 is in retention mode, the system controller 20 may be responsive to assertion of the service signal 40 to switch the cache 8 to the normal mode.

The system controller 20 may also control the current operating mode of the cache 8 in response to a sleep/wake up signal 44 received from the processing circuit 4 associated with the cache 8. Hence, the processing circuit 4 can indicate to the system controller 20 that the cache 8 should be placed in either the normal mode or the retention mode. While the cache 8 is in retention mode, the processing circuit 4 would usually also be placed in a power saving state.

While the cache 8 and the cache control logic 24 are in the retention mode, the other device 6 can continue to perform non-coherent access requests 50 in respect of data in the memory 12. The non-coherent access requests 50 are requests for data for which coherency with data in the cache 8 is not required. For example, there may be some regions of memory 12 which are not accessible to the processing circuit 4 and cache 8, and so when accessing data stored in those regions there is no need for the other device 6 to issue any coherency access requests to the cache 8.

For conciseness, FIG. 1 illustrates an example in which only the cache 8 is provided with the retention mode, power controller 20 and access control gate 30. However, it will be appreciated that in other embodiments the cache 10 of the other device 6 may also be provided with a similar power controller 20 for implementing a retention mode and an access control gate 30 for controlling switching of the cache 10 to the normal mode when a cache coherency request is received from the device 4. Also, further devices, with or without the power controller 20 and access control gate 30, may also be connected to the interconnect 14.

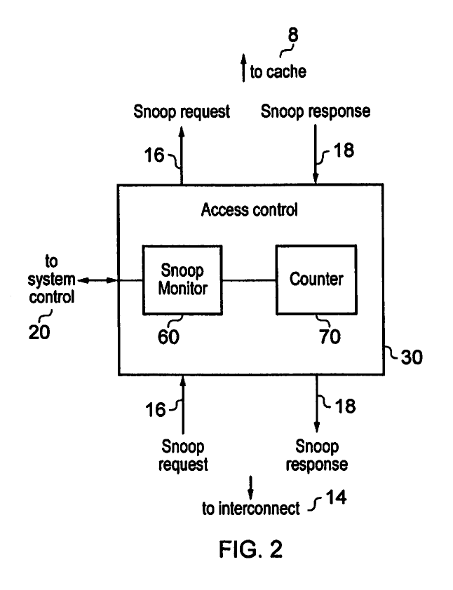

FIG. 2 shows an example of the access control unit 30 comprising a snoop monitor 60 for monitoring snoop access requests 16 received from the interconnect 14, determining whether to pass the snoop access request 16 to the cache 8 based on whether the cache is in the normal mode or retention mode, and monitoring snoop responses received from the cache in response to the snoop access requests 60. A counter 70 may be provided for keeping track of whether snoop responses have been received for all snoop access requests issued to the cache 8. The counter has a predetermined value (for example, zero) when the number of snoop responses received from the cache 8 is the same as the number of snoop access requests 16 issued to the cache 8. For each snoop access request 16 issued to the cache, the counter 70 is incremented and for each snoop response 18 received from the cache the counter is decremented. If a snoop access request 16 is issued to the cache at the same time as a snoop response 18 is received, then the counter may remain at the same value. When the system controller 20 signals that it is about to switch the cache 8 to the retention mode, the snoop monitor 60 may check the value of the counter 70 and prevent the system controller 20 from switching the cache 8 to the retention mode until the counter 70 is at the predetermined value (indicating that snoop responses 18 have been received for all issued snoop requests 16). At this point, the snoop monitor 60 may block further snoop requests 16 from being issued to the cache and continue blocking such requests until the system controller 20 signals that the cache has returned from the retention mode to the normal mode.

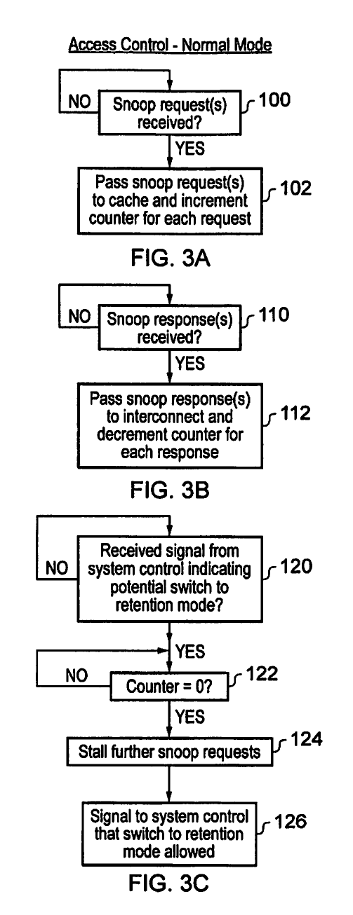

FIGS. 3A, 3B and 3C show functions performed by the coherency controller 30 while the cache 8 is in the normal mode. The functions illustrated in FIGS. 3A, 3B and 3C would be performed substantially simultaneously by the snoop monitor 60 of the access controller 30.

As shown in FIG. 3A at step 100, the access controller 30 checks whether any snoop access requests 16 have been received via the interconnect 14 from another device 6. When one or more snoop access requests 16 are received, then at step 102 the access controller 30 passes the received snoop access request(s) to the cache 8 and increments the counter 70 for each request passed to the cache.

Meanwhile, as shown in FIG. 3B, the access controller 30 checks whether any snoop responses have been received from the cache 8 (step 110). When a snoop response is received, then at step 112 the access controller 30 passes a snoop response to the interconnect 14 for routing to the device which initiated the corresponding snoop access request 16. For each snoop response received from the cache 8, the access controller 30 decrements the counter 70.

Also, as shown in FIG. 3C, while the cache 8 is in the normal mode, the access controller 30 checks whether the request signal 34 has been received from the system controller 20 indicating a potential switch of the cache 8 to the retention mode (step 120). When the request signal 34 is received, then at step 122 the access controller 30 checks whether the counter 70 has the predetermined initial value (in this example, a value of 0) indicating that snoop responses have been received for all snoop requests issued to the cache 8. If the counter value is not equal to the initial value, then the switch to the retention mode is deferred. Once the counter has the initial value, then at step 124 the access controller 30 stalls any further snoop requests received from the interconnect 14 to prevent them from being issued to the cache 8 as the cache is being switched to the retention mode. At step 126, the coherency controller 30 then issues the ready signal 36 to signal to the system controller 20 that the cache 8 can now be switched to the retention mode. Any snoop requests which have been stalled at step 124 continue to be asserted by the device 6 which issued the request to ensure that they are serviced when the cache 8 returns to the normal mode.

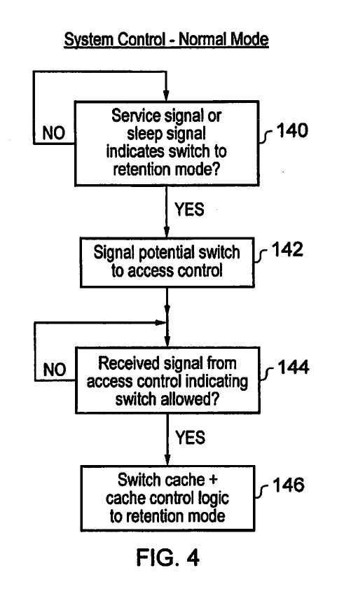

FIG. 4 shows functions performed by the system controller 20 (the power controller) while the cache 8 is in the normal mode. At step 140 the system controller 20 checks to see whether the service signal 40 or the sleep signal 44 indicates that the cache 8 should be switched to the retention mode. If so, then at step 142 the system controller 20 sends the request signal 34 to the access controller 30 to signal that there is a potential switch to retention mode. At step 144, the system controller 20 waits to receive the ready signal 36 from the access controller 30 indicating that the switch to retention mode is allowed. Step 144 corresponds to steps 122 to 126 of FIG. 3C in which the access controller 30 is checking whether snoop responses have been received for all the issued snoop access requests. After the access controller 30 has signalled that the switch to retention mode is allowed, then at step 146 the system controller 20 switches the cache 8 and the cache control logic 24 to the retention mode.

As shown in FIGS. 3C and 4, by checking that all issued snoop access requests have been serviced before switching to the retention mode and, after determining that all previously issued access requests have been serviced, stalling any further access requests received from the interconnect, it can be ensured that at the point that the cache is switched to retention mode there cannot be any outstanding access requests which have been sent to the cache but not serviced. This ensures that no access requests are missed and that data coherency between the data in the cache and data in another device is maintained.

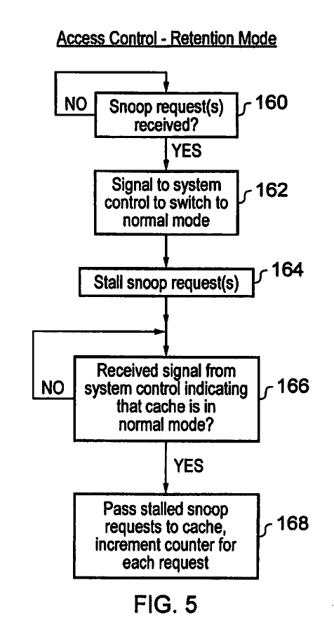

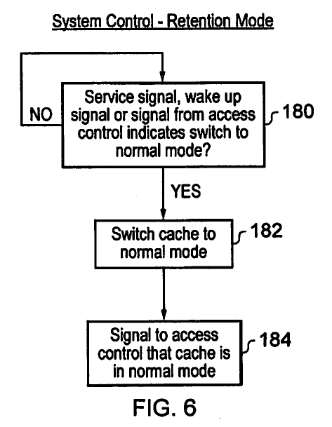

FIGS. 5 and 6 show functions performed by the access controller 30 and the system controller 20 respectively while the cache 8 is in the retention mode. At step 160 of FIG. 5, the access controller 30 checks whether any snoop access requests 16 have been received via the interconnect 14. If so, then at step 162 the access controller 30 signals to the system controller 20 that the cache 8 should be switched to the normal mode of operation. The access controller 30 then stalls the received snoop access request(s) at step 164 so that they are prevented from being issued to the cache 8 while the cache 8 is still in retention mode. The stalled access request(s) continue to be asserted by the device(s) which issued the request(s). At step 166 the access controller 30 waits for a signal from the system controller 20 indicating that the cache is in the normal mode. Once such a signal has been received, then at step 168 the access controller 30 passes the stalled snoop requests to the cache. The counter 70 is incremented for each request in a similar way to step 102 of FIG. 3A to allow the access controller 30 to monitor whether all issued requests have been serviced by the cache.

Meanwhile, at step 180 of FIG. 6, the system controller 20 monitors the service signal 40, the wake up signal 44 from the processing circuit 4 and the signal from the access controller 30 to see whether any of these signals indicate that the cache 8 should be switched to the normal mode. If so, then the at step 182 the system controller 20 increases the power supply to the cache 8 and cache control logic 24 to switch the cache to the normal mode of operation. At step 184, the system controller 20 signals to the access controller 30 that the cache is now in the normal mode so that the access controller can pass any stalled access requests to the cache for servicing. Hence, at steps 162 of FIGS. 5 and 180 of FIG. 6, the access controller 30 can trigger the system controller 20 to wake up the cache 8 if a coherency access request is received via the interconnect 14, to allow the cache 8 to respond to the coherency access request and to maintain coherency.

While FIGS. 3A to 6 show example sequences of steps, it will be appreciated that some of these steps may be performed in parallel with one another or in a different order to the order illustrated.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A data processing apparatus comprising:
a cache having a normal mode of operation and a retention mode of operation in which said cache consumes less power than in said normal mode;
an interconnect configured to receive from at least one other device coherency access requests for data stored in said cache, wherein in said normal mode said data stored in said cache is accessible and said cache is configured to generate coherency responses in response to said coherency access requests, and in said retention mode said data is retained in said cache but is inaccessible in response to said coherency access requests;
a power controller configured to control switching of said cache between said normal mode and said retention mode; and
a coherency controller coupled between said cache and said interconnect and configured to monitor said coherency access requests received via said interconnect and said coherency responses generated by said cache;
wherein on switching said cache from said normal mode to said retention mode, said power controller is configured to defer switching said cache to said retention mode until said coherency controller has detected coherency responses for all coherency access requests passed to said cache.

2. The data processing apparatus according to claim 1, wherein said coherency controller is configured to trigger said power controller to switch said cache to said normal mode if at least one coherency access request is received via said interconnect while said cache is in said retention mode.

3. The data processing apparatus according to claim 1, wherein said coherency controller comprises an access gate configured to intercept coherency access requests received via said interconnect and select whether to pass said coherency access requests to said cache or stall said coherency access requests.

4. The data processing apparatus according to claim 1, wherein while said cache is in said normal mode said coherency controller is configured to pass said coherency access requests received via said interconnect to said cache.

5. The data processing apparatus according to claim 2, wherein said coherency controller is configured to stall said at least one coherency access request received while said cache is in said retention mode until said power controller has switched said cache to said normal mode.

6. The data processing apparatus according to claim 5, wherein said coherency controller is configured to pass the stalled at least one coherency access request to said cache after said power controller has switched said cache to said normal mode.

7. The data processing apparatus according to claim 1, wherein said coherency controller is configured to count a number of coherency access requests passed to said cache and a number of coherency responses received from said cache; and
said power controller is configured to defer switching said cache to said retention mode until said coherency controller detects that said number of coherency responses is the same as said number of coherency access requests.

8. The data processing apparatus according to claim 7, wherein said coherency controller comprises a counter having a predetermined value when said number of coherency access requests passed to said cache is the same as said number of coherency responses received from said cache;
said coherency controller is configured to increment said counter when a coherency access request is passed to said cache and to decrement said counter when a coherency response is received from said cache; and
said power controller is configured to defer switching said cache to said retention mode until said counter has said predetermined value.

9. The data processing apparatus according to claim 8, wherein said predetermined initial value is zero.

10. The data processing apparatus according to claim 1, wherein after detecting that coherency responses have been received from said cache for all coherency access requests received via said interconnect, said coherency controller is configured to prevent further coherency access requests from being passed to said cache until said cache is switched from said retention mode to said normal mode.

11. The data processing apparatus according to claim 1, comprising cache control circuitry for controlling said cache, wherein during said retention mode said cache control circuitry is placed in a power saving state.

12. The data processing apparatus according to claim 1, wherein said power controller is configured to switch said cache to said normal mode in response to a service signal received from said at least one other device or an external device while said cache is in said retention mode.

13. The data processing apparatus according to claim 1, comprising a processing circuit for performing processing operations, said cache storing data for said processing circuit;
wherein said power controller is configured to switch said cache to said normal mode in response to a wakeup request received from said processing circuit while said cache is in said retention mode.

14. The data processing apparatus according to claim 1, wherein said at least one other device is configured to issue non-coherent access requests for data in a memory while said cache is in said retention mode.

15. The data processing apparatus according to claim 1, comprising at least one of said at least one other device coupled to said interconnect.

16. The data processing apparatus according to claim 1, wherein said at least one other device includes at least one external device.

17. A data processing apparatus comprising:
cache means for storing data, said cache means having a normal mode of operation and a retention mode of operation in which said cache means consumes less power than in said normal mode;
interconnect means for receiving from at least one other device coherency access requests for data stored in said cache means, wherein in said normal mode said data is accessible and said cache means is configured to generate coherency responses in response to said coherency access requests, and in said retention mode said data is retained but is inaccessible in response to said coherency access requests;
power control means for controlling switching of said cache means between said normal mode and said retention mode; and
coherency control means, coupled between said cache means and said interconnect means, for monitoring said coherency access requests received via said interconnect means and said coherency responses generated by said cache means;
wherein on switching said cache means from said normal mode to said retention mode, said power control means is configured to defer switching said cache means to said retention mode until said coherency control means has detected coherency responses for all coherency access requests passed to said cache means.

18. A method comprising steps of:
storing data in a cache having a normal mode of operation and a retention mode of operation in which said cache consumes less power than in said normal mode;
receiving, from at least one other device via an interconnect, coherency access requests for data stored in said cache, wherein in said normal mode said data is accessible and said cache generates coherency responses in response to said coherency access requests and in said retention mode said data is retained but is inaccessible in response to said coherency access requests;
monitoring said coherency access requests received via said interconnect and said coherency responses generated by said cache using a coherency controller coupled between said cache and said interconnect; and
on switching said cache from said normal mode to said retention mode, deferring switching said cache to said retention mode until said coherency controller has detected coherency responses for all coherency access requests passed to said cache.
